(19) United States
(12) Patent Application Publication
(10) Pub. No.: US 2026/0329210 A1
(43) Pub. Date: Oct. 22, 2026

(54) IMAGE FORMING APPARATUS

(71) Applicant: CANON KABUSHIKI KAISHA, Tokyo (JP)

(72) Inventors: HOSU YEU, Shizuoka (JP); NAOKI FUKUSHIMA, Shizuoka (JP)

(21) Appl. No.: 19/634,699

(22) Filed: Mar. 31, 2026

(30) Foreign Application Priority Data
Apr. 16, 2025 (JP) 2025-067694

(51) Int. Cl. G03G 15/00; G03G 21/00

(52) U.S. Cl. CPC G03G 15/50; G03G 15/6508; G03G 15/6511; G03G 15/6514; G03G 21/0005

(57) ABSTRACT

Disclosed is an image forming apparatus including a control unit configured to execute (i) an image forming operation and (ii) a toner supplying operation. The control unit is configured to set a first toner amount and a second toner amount to different amounts, the first toner amount being an amount of toner to be supplied to the contact portion by the toner supplying operation when executing the toner supplying operation after the image forming operation performed to a sheet conveyed to the transfer portion via a first conveyance path, the second toner amount being an amount of toner to be supplied to the contact portion by the toner supplying operation when executing the toner supplying operation after the image forming operation performed to a sheet conveyed to the transfer portion via a second conveyance path that differs from the first conveyance path.

### BACKGROUND

### Field of the Technology

The present disclosure relates to an image forming apparatus for forming images on sheets.

### Description of the Related Art

Japanese Patent Application Laid-Open No. 2016-75768 discloses interrupting a continuous image forming job, rotating an intermediate transfer belt in a reverse direction, and removing paper dust caught between the intermediate transfer belt and a cleaning blade. Japanese Patent Application Laid-Open No. S63-172295 discloses a method of attaching toner to a photosensitive drum at sheet intervals and supplying toner to a contact portion between the cleaning blade and the photosensitive drum to thereby maintain cleaning performance.

### SUMMARY

An aspect of the present disclosure provides an image forming apparatus including a photosensitive drum configured to rotate, a transfer member configured to form a transfer portion at which a toner image is transferred from the photosensitive drum to a sheet, a cleaning member configured to come into contact with the photosensitive drum and remove toner that has not been transferred to the sheet at the transfer portion from a surface of the photosensitive drum, and a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum, wherein the control unit is configured to set a first toner amount and a second toner amount to different amounts, the first toner amount being an amount of toner to be supplied to the contact portion by the toner supplying operation when executing the toner supplying operation after the image forming operation performed to a sheet conveyed to the transfer portion via a first conveyance path, the second toner amount being an amount of toner to be supplied to the contact portion by the toner supplying operation when executing the toner supplying operation after the image forming operation performed to a sheet conveyed to the transfer portion via a second conveyance path that differs from the first conveyance path.

Another aspect of the present disclosure provides an image forming apparatus including a photosensitive drum configured to rotate, a transfer member configured to form a transfer portion at which a toner image is transferred to a sheet from the photosensitive drum, a conveyance roller configured to convey a sheet toward the transfer portion, a separation member configured to form a separation nip together with the conveyance roller, and to separate the sheet by applying a frictional force to sheets at the separation nip, in an opposite direction as a direction in which the sheet is conveyed by the conveyance roller, a cleaning member configured to come into contact with the photosensitive drum and remove toner that has not been transferred to the sheet at the transfer portion from a surface of the photosensitive drum, and a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum, wherein the conveyance roller includes an outer circumference surface that comes into contact with a sheet, and wherein the control unit is configured to set a width of the predetermined toner image with respect to a direction of rotation of the photosensitive drum in a first area to be greater than a width of the predetermined toner image in an area other than the first area, the first area corresponding to a range in which the outer circumference surface is disposed in a rotational axis direction of the photosensitive drum.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic view of an image forming apparatus according to a first embodiment, and FIG. 1B is a cross-sectional view of a process cartridge thereof.

FIG. 2 is an enlarged view illustrating a contact portion of a cleaning blade and a photosensitive drum according to the first embodiment.

FIG. 3 is a block diagram related to control of the image forming apparatus according to the first embodiment.

FIG. 4 is an explanatory view of a sheet conveyance path of the image forming apparatus according to the first embodiment.

FIG. 5 is a flowchart illustrating an execution sequence of an image forming job according to the first embodiment.

FIGS. 6A and 6B are each an explanatory view of a toner pattern in a toner purge operation according to the first embodiment and a second embodiment.

FIG. 7 is a flowchart illustrating an execution sequence of an image forming job according to the second embodiment.

FIG. 8 is a schematic view of an image forming apparatus according to a third embodiment.

### DESCRIPTION OF THE EMBODIMENTS

Embodiments related to the present disclosure will be described below with reference to the drawings.

### First Embodiment

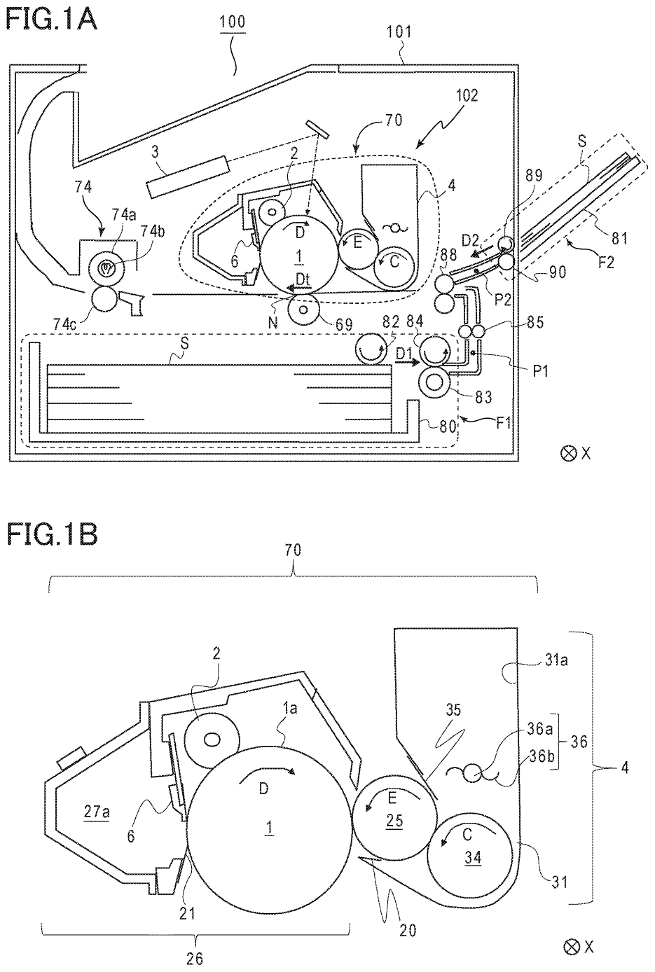

FIG. 1A is a schematic view illustrating a cross-section of an image forming apparatus 100 according to one embodiment, i.e., first embodiment. An image forming apparatus 100 is a monochrome laser printer that forms an image on a sheet S by an electrophotographic process using black toner as developer based on an image information received from an external computer. Various types of sheet members of different sizes and materials, such as paper including normal paper and thick paper, sheet members having surface treatments applied thereto such as coated paper, sheet members having special shapes such as envelopes and index paper, plastic films, and cloths, may be used as the sheet S serving as the recording material, i.e., recording medium.

The term “image forming apparatus” is not limited to a single function printer having only an image forming function, i.e., printing function, and may refer to a copying machine for copying documents, a facsimile, or a multifunction apparatus having combined such functions.

### Image Forming Apparatus

As illustrated in FIG. 1A, the image forming apparatus 100 includes an apparatus body 101, and a process cartridge 70 detachably attached to the apparatus body 101. The apparatus body 101 according to the present embodiment refers to a portion of the image forming apparatus 100 excluding the process cartridge 70.

The image forming apparatus 100 includes an image forming portion 102, a fixing portion 74, a cassette sheet feed portion F1, a manual sheet feed portion F2, and a registration roller pair 88. The image forming portion 102, the fixing portion 74, and the cassette sheet feed portion F1 are accommodated in the apparatus body 101. The above-mentioned components of the image forming apparatus 100 will be described below, but the cassette sheet feed portion F1 and the manual sheet feed portion F2 are described later.

The image forming portion 102 includes the process cartridge 70, a scanner unit 3 serving as an exposing unit, and a transfer roller 69 serving as a transfer member. The process cartridge 70 is a unit including a photosensitive drum 1 serving as an image bearing member, and at least one processing member that acts on the photosensitive drum 1 to execute respective steps of the electrophotographic process, such as charging, exposing, developing, transferring, and cleaning.

As illustrated in FIG. 1B, the process cartridge 70 according to the present embodiment includes the photosensitive drum 1, a charging roller 2 serving as a charging unit, a developing apparatus 4, and a cleaning blade 6 serving as a cleaning member. The photosensitive drum 1, the charging roller 2, and the cleaning blade 6 may be collectively referred to as a charging/cleaning unit 26 or a drum unit.

The photosensitive drum 1 is a photosensitive member for electrophotography in which a photosensitive layer including an organic photosensitive material is formed on an outer circumference portion of a cylindrical metal base. During execution of an image forming operation, i.e., during forming of image and printing, the photosensitive drum 1 is driven to rotate in an arrow D direction in the drawing.

The charging roller 2 is disposed to be in contact with a surface, i.e., outer circumference surface, of the photosensitive drum 1. An opposing portion between the photosensitive drum 1 and the charging roller 2 is referred to as a charging portion, i.e., charging position. The charging roller 2 co-rotates with the photosensitive drum 1 by a frictional force applied from a surface 1a of the photosensitive drum 1 in a state where the photosensitive drum 1 is driven. A corotron-type or scorotron-type charging device for charging the surface of the photosensitive drum 1 by performing discharge from a wire may be adopted as the charging unit.

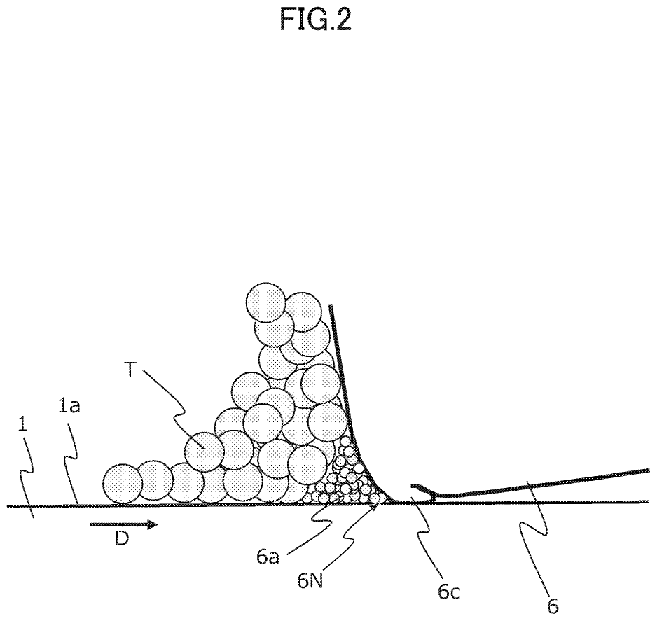

The cleaning blade 6 includes a rubber blade formed of an elastic material, and a support member such as a sheet metal that supports the rubber blade. The support member is attached to a frame body of the charging/cleaning unit 26. An edge portion 6c, i.e., tip portion, of the cleaning blade 6 forms a blade nip 6N (FIG. 2) serving as a contact portion where the cleaning blade 6 and the surface 1a of the photosensitive drum 1 contact each other. The cleaning blade 6 removes attachments such as transfer residual toner and paper dust from the surface 1a of the photosensitive drum 1 at the blade nip 6N, i.e., contact portion.

The edge portion 6c of the cleaning blade 6 according to the present embodiment is in pressure contact with the surface of the photosensitive drum 1 in a counter direction with respect to a direction of rotation of the photosensitive drum 1 illustrated by arrow D. The counter direction is where a direction of the cleaning blade 6 from a base portion toward a tip is oriented upstream with respect to a direction of movement of the surface 1a of the photosensitive drum 1 at the blade nip 6N.

The charging/cleaning unit 26 includes a removed toner chamber 27a that stores the transfer residual toner removed from the surface 1a of the photosensitive drum 1 by the cleaning blade 6, and a scooping sheet 21 that prevents contents of the removed toner chamber 27a from leaking to the exterior of the cartridge.

The developing apparatus 4 includes a developer frame body 31, i.e., developer container, in which a toner storage chamber 31a, i.e., toner storage portion, storing toner serving as developer is formed, a developing roller 25, a feed roller 34, a developing blade 35, a stirring member 36, and a blowout prevention sheet 20. An opposing portion of the photosensitive drum 1 and the developing roller 25 serves as a developing portion, i.e., developing position. During image formation, the developing roller 25 and the feed roller 34 are each driven to rotate in directions of arrows E and C in the drawing.

The developing roller 25 functions as a developer bearing member that bears toner from the toner storage chamber 31a and supplies the same to the photosensitive drum 1 at the developing portion. The feed roller 34 supplies toner from the toner storage chamber 31a to the developing roller 25. The stirring member 36 includes a stirring shaft 36a that rotates by receiving driving force, and a sheet member 36b that rotates together with the stirring shaft 36a, stirring the toner within the toner storage chamber 31a by the sheet member 36b. The developing blade 35 is disposed to contact the outer circumference surface of the developing roller 25. The developing blade 35 regulates the amount of toner to be supplied to the developing portion, i.e., toner coat thickness, and raises the charged amount of toner via frictional charging by rubbing the toner borne on the developing roller 25. The blowout prevention sheet 20 prevents toner from leaking through a gap formed between the developing roller 25 and the developer frame body 31 arranged at the opening portion of the developer frame body 31.

As illustrated in FIG. 1, the scanner unit 3 is disposed above the process cartridge 70. The scanner unit 3 includes a laser light source, and an optical system such as a polygon mirror that guides the light emitted from the laser light source toward the photosensitive drum 1. Further, an LED exposing device in which LED is used as light source may be adopted as the exposing unit.

The transfer roller 69 is in contact with the photosensitive drum 1. A transfer nip N serving as a transfer portion where a toner image is transferred to the sheet S is formed between the photosensitive drum 1 and the transfer roller 69. The transfer roller 69 is an example of a transfer member forming the transfer portion, and for example, a corona discharge-type transfer unit may be used.

The fixing portion 74 includes a fixing roller 74a serving as a heating member, i.e., fixing member, a halogen lamp 74b serving as a heating unit for heating the fixing roller 74a, and a pressure roller 74c in pressure contact with the fixing roller 74a. A fixing nip is formed between the fixing roller 74a and the pressure roller 74c. The fixing portion 74 may be a film heating-type device in which a tubular film is used as the heating member and a ceramic heater is used as the heating unit disposed in an inner space of the film. The heating unit may be a coil that heats a conducting layer within the heating member by principle of induction heating.

### Image Forming Operation

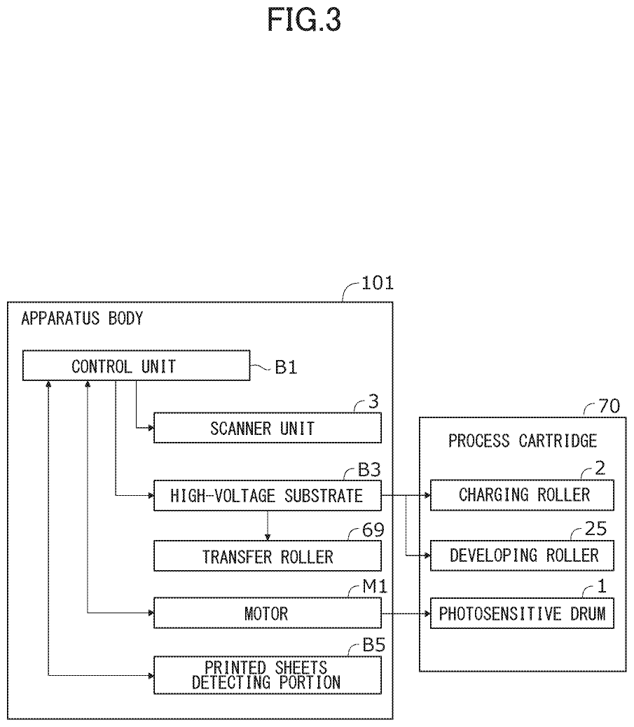

An image forming operation of the image forming apparatus 100 will be described. The image forming operation is a series of operations, also referred to as a printing operation, in which the image forming apparatus 100 forms image on the sheets S while feeding the sheets S one by one. Further, the image forming operation is an operation in which a toner image formed on the surface 1a of the photosensitive drum 1 is transferred to a sheet at the transfer nip N, i.e., transfer portion. A control unit B1 (FIG. 3) of the image forming apparatus 100 executes the image forming operation in a case where an image information is received together with an instruction to execute image forming from a user.

In the image forming operation, the photosensitive drum 1 is driven to rotate at a predetermined peripheral speed, i.e., processing speed, in the arrow D direction of FIG. 1. A predetermined bias voltage, i.e., charging voltage, is applied to the charging roller 2, which charges the surface 1a of the photosensitive drum 1 uniformly to a predetermined polarity and potential. The scanner unit 3 is driven by an image signal, i.e., video signal, generated based on an image information provided when an image forming job is entered, and irradiates laser light to the surface 1a of the photosensitive drum 1. Thereby, the photosensitive drum 1 is exposed, and an electrostatic latent image based on the image information is formed on the surface 1a of the photosensitive drum 1.

The developing apparatus 4 supplies toner to the photosensitive drum 1 by the developing roller 25, and develops the electrostatic latent image into a toner image at the developing portion. At the developing portion, toner is selectively transferred from the developing roller 25 to an image area of the photosensitive drum 1 according to a potential difference between a developing voltage applied to the developing roller 25 and a surface potential of the photosensitive drum 1.

Specifically, a reversal development system is adopted according to the present embodiment. In this case, a surface potential, i.e., dark potential, of the photosensitive drum 1 after being charged by the charging roller 2 is of a same polarity, such as negative polarity, as a normal charge polarity of toner. The scanner unit 3 irradiates an area, i.e., image area, to which a toner image is to be formed on the surface 1a of the photosensitive drum 1 with light, and attenuates the surface potential of the photosensitive drum 1 at the image area. When the developing voltage is set as reference, a potential of the image area, i.e., light potential, has an opposite polarity as a normal charge polarity of toner, and a potential of a non-image area, i.e., dark potential, has the same polarity as the normal charge polarity of toner. Therefore, toner borne on the developing roller 25 and reaching the developing portion is transferred to the image area on the photosensitive drum 1 while toner remains on the developing roller 25 without being transferred to the non-image area. Thereby, a toner image corresponding to the electrostatic latent image is formed on the photosensitive drum 1.

In parallel with the operation described above, a sheet S is fed toward the image forming portion 102 from the cassette sheet feed portion F1 or the manual sheet feed portion F2. The sheet S being fed is subjected to skew correction by the registration roller pair 88, and then conveyed to the transfer nip N. While the sheet S passes through the transfer nip N, a toner image is transferred from the photosensitive drum 1 to the sheet S by application of transfer voltage to the transfer roller 69.

The sheet S having passed through the transfer nip N is subjected to an image fixing process at the fixing portion 74. The fixing portion 74 heats and presses the toner image on the sheet S while nipping and conveying the sheet S by the fixing nip. The sheet S having passed through the fixing portion 74 is discharged to an exterior of the apparatus body 101 by the sheet discharge roller pair, and supported on a sheet discharge tray disposed on an upper surface of the apparatus body 101.

### Sheet Conveyance Path

A configuration of the cassette sheet feed portion F1 and the manual sheet feed portion F2 provided in the image forming apparatus 100 of the first embodiment, and a sheet conveyance path from the cassette sheet feed portion F1 or the manual sheet feed portion F2 to the transfer nip N will be described.

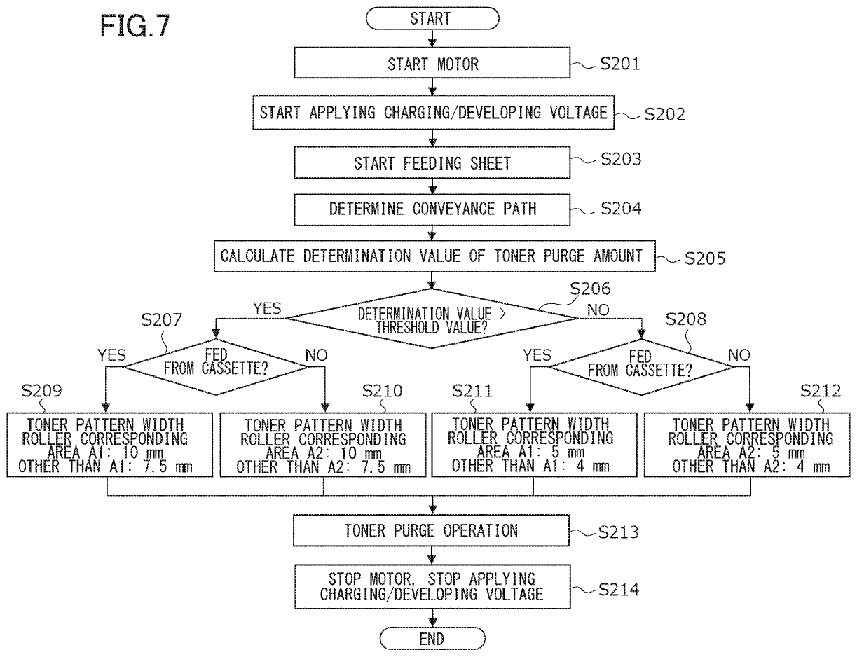

As illustrated in FIG. 1A, the cassette sheet feed portion F1 includes a sheet cassette 80, a pickup roller 82, a feed roller 84, a separation roller 83, conveyance guides 91 and 92 (FIG. 7), and a relay roller pair 85.

The sheet cassette 80 is an example of a first supporting portion on which the sheet S used as the recording material is supported. Further, the sheet cassette 80 is a sheet storage portion, i.e., storage or sheet supporting portion, in which the sheet S is stacked and stored. The sheet S supported on the sheet cassette 80 is conveyed to the transfer nip N via a conveyance path, i.e., first conveyance path P1, described later. The sheet cassette 80 is attached to a lower portion of the apparatus body 101 so as to be drawable therefrom.

The pickup roller 82 is arranged above the sheet cassette 80, and sends out the sheet S from the sheet cassette 80 toward a first feeding direction D1 by rotating in contact with an uppermost sheet S of a sheet bundle in the sheet cassette 80. The feed roller 84 is disposed downstream of the pickup roller 82 in the first feeding direction D1 and conveys the sheet S further. The separation roller 83 comes into pressure contact with the feed roller 84, and applies a frictional force in a direction opposite to the first feeding direction D1 to the sheet S at a separation nip Ns1 formed between the feed roller 84 and the separation roller 83. Thereby, the separation roller 83 prevents the sheet S other than the uppermost sheet S in contact with the feed roller 84 from passing through the separation nip Ns1 in a case where a plurality of sheets S are sent out by the pickup roller 82.

The separation roller 83 may be a roller that is supported via a torque limiter to a non-rotatable fixing shaft supported on a frame body of the apparatus body 101. The separation roller 83 may be a roller, i.e., retard roller, to which a driving force in a direction opposite to a direction co-rotating with the feed roller 84 is entered via a torque limiter from the motor disposed in the apparatus body 101. Further, the separation roller 83 is an example of a separation member that applies frictional force to the sheet S to separate the sheet S, and for example, a pad-shaped elastic member that comes into contact with the feed roller 84 may be used as the separation member.

The conveyance guides 91 and 92 form at least a portion of a conveyance path, i.e., the first conveyance path P1, through which the sheet S conveyed from the sheet cassette 80 toward the transfer nip N passes. The relay roller pair 85 is disposed between the feed roller 84 and the registration roller pair 88 in the first conveyance path P1, and conveys the sheet S having passed through the separation nip Ns1 toward the registration roller pair 88. If the distance from the feed roller 84 to the registration roller pair 88 is short, the relay roller pair 85 may be omitted.

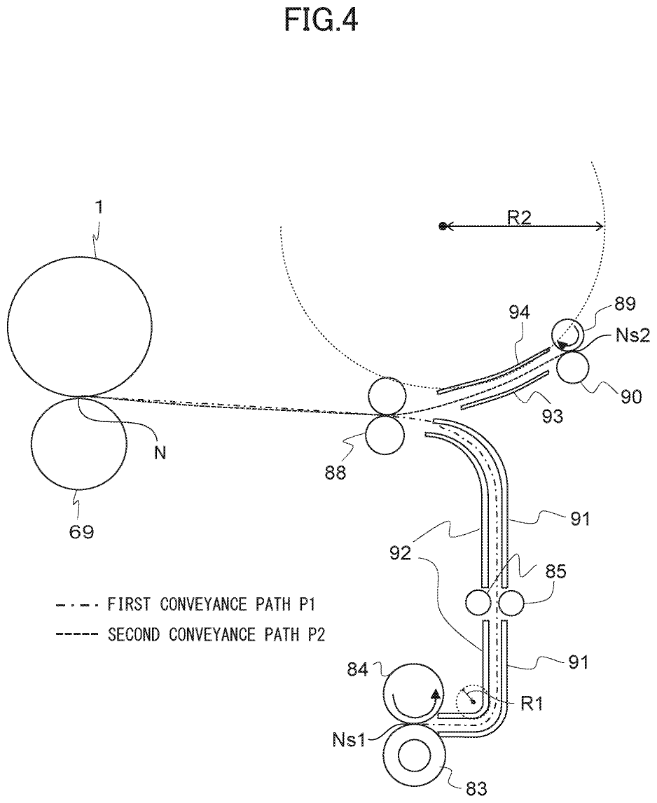

The manual sheet feed portion F2 includes a manual feed tray 81, a feed roller 89, a separation roller 90, and conveyance guides 93 and 94 (FIG. 4).

The manual feed tray 81 is a second supporting portion on which the sheets S used as the recording material are supported, and it is an example of the second supporting portion on which the sheets S conveyed via a conveyance path, i.e., second conveyance path P2, that differs from the conveyance path, i.e., the first conveyance path P1, of the sheet S supported on the first supporting portion are supported. Further, the manual feed tray 81 is a sheet stacking portion or sheet supporting portion on which the sheet S is supported. The manual feed tray 81 is disposed to protrude to the exterior of the apparatus body 101. The user can access the manual feed tray 81 from the exterior of the image forming apparatus 100 and set the sheets S on the manual feed tray 81.

The feed roller 89 is disposed above the manual feed tray 81, and sends out the sheet S from the manual feed tray 81 toward a second feeding direction D2 by rotating in contact with an uppermost sheet S on the manual feed tray 81. The separation roller 90 comes into pressure contact with the feed roller 89, and applies a frictional force in a direction opposite to the second feeding direction D2 to the sheet S at a separation nip Ns2 formed between the feed roller 89 and the separation roller 90. Thereby, the separation roller 90 prevents the sheet S other than the uppermost sheet S in contact with the feed roller 89 from passing through the separation nip Ns2.

The separation roller 90 may be a roller that is supported via a torque limiter on the fixing shaft, or a roller, i.e., retard roller, to which a driving force in a direction opposite to the direction co-rotating with the feed roller 84 is entered via the torque limiter. Further, the separation roller 90 is an example of a separation member that applies frictional force to the sheet S to separate the sheet S, and for example, a pad-shaped elastic member that comes into contact with the feed roller 89 may be used as the separation member.

The conveyance guides 93 and 94 form at least a portion of a conveyance path, i.e., the second conveyance path P2, through which the sheet S conveyed from the manual feed tray 81 toward the transfer nip N passes. If the distance from the feed roller 89 to the registration roller pair 88 is long, there may be one or more relay roller pairs additionally disposed between the feed roller 89 and the registration roller pair 88.

A direction of movement of the sheet S at the transfer nip N is referred to as a transfer conveyance direction Dt. In this case, a sheet conveyance direction from the sheet cassette 80, i.e., the first feeding direction D1, and a sheet conveyance direction from the manual feed tray 81, i.e., the second feeding direction D2, are oriented toward opposite directions with respect to directions parallel to the transfer conveyance direction Dt. That is, a component of the first feeding direction D1 parallel to the transfer conveyance direction Dt is oriented opposite to the transfer conveyance direction Dt, and a component of the second feeding direction D2 parallel to the transfer conveyance direction Dt is oriented in the same direction as the transfer conveyance direction Dt.

In other words, the feed roller 84 of the cassette sheet feed portion F1 is an example of a first feeding member that feeds the sheets supported on the first supporting portion toward a side opposite to the direction of movement of the sheet at the transfer portion, with respect to a direction parallel to the above-mentioned direction of movement. The feed roller 89 of the manual sheet feed portion F2 is an example of a second feeding member that feeds the sheets supported on the second supporting portion toward a same side as the above-mentioned direction of movement, with respect to a direction parallel to the above-mentioned direction of movement. Therefore, the sheet S fed from the first feeding member is turned toward the transfer conveyance direction Dt in the first conveyance path, during which state paper dust tends to occur.

In the present embodiment, the conveyance path, i.e., the first conveyance path P1, from the sheet cassette 80 toward the transfer nip N is curved approximately in a U shape. At least a portion of the first conveyance path P1 is curved such that a conveyance direction of the sheet S fed from the sheet cassette 80 toward the first feeding direction D1 is oriented toward an opposite side as the first feeding direction D1 before the sheet S reaches the transfer nip N. In other words, the first conveyance path P1 is curved such that the sheet fed by the feed roller 84, i.e., first feeding member, toward an opposite side as the transfer conveyance direction Dt, i.e., direction of movement, is guided toward a direction corresponding to the transfer conveyance direction Dt, i.e., direction of movement.

More specifically, the conveyance guides 91 and 92 according to the present embodiment form a conveyance path that is curved approximately in a U shape between the feed roller 84 and the registration roller pair 88. That is, the first conveyance path P1 is formed to receive the sheet S fed toward the first feeding direction D1 toward one side in the horizontal direction, i.e., right side in the drawing of FIG. 1A, and to send out the sheet S toward the other side in the horizontal direction, i.e., left side in the drawing. The registration roller pair 88 conveys the sheet S in the direction along the transfer conveyance direction Dt.

### Control Configuration

A control configuration of the image forming apparatus 100 will be described below. FIG. 3 is a block diagram illustrating a hardware configuration of the image forming apparatus 100 according to the first embodiment.

The control unit B1, a high-voltage substrate B3, a printed sheets detecting portion B5, and a motor M1 are disposed in the apparatus body 101 of the image forming apparatus 100. The control unit B1 sends instructions to and controls the operations of the scanner unit 3, the high-voltage substrate B3, and various loads such as the motor. The control unit B1 is an example of a controller or a control circuit for controlling the operation of the image forming apparatus 100. The control unit B1 executes the aforementioned image forming operation or a toner purge operation, i.e., toner supplying operation, described later. The control unit B1 includes a CPU that executes programs for controlling the image forming apparatus 100, and a storage unit, i.e., memory, that stores programs and data and also provides a workplace for the CPU.

The high-voltage substrate B3 includes a voltage generation circuit that generates voltages as an AC or DC high voltage from an AC voltage supplied from a commercial power supply outside the apparatus. Various voltages include a bias voltage, i.e., charging voltage, applied to the charging roller 2, a bias voltage, i.e., developing voltage, applied to the developing roller 25, and a bias voltage, i.e., transfer voltage, applied to the transfer roller 69. Electric components such as the charging roller 2 and the developing roller 25 which are targets to which voltage is applied in the process cartridge 70 are electrically connected to the high-voltage substrate B3 via a contact portion where a terminal, i.e., contact, of the process cartridge 70 and a terminal, i.e., contact, of the apparatus body 101 contact each other.

The printed sheets detecting portion B5 can count an accumulated number of times the image forming operation has been executed by the image forming apparatus 100, i.e., accumulated number of printed sheets. The printed sheets detecting portion B5 may be implemented as a dedicated circuit independent from the control unit B1, or may be realized as a function of a program executed by the CPU of the control unit B1.

The motor M1 is connected to the process cartridge 70 via a coupling and a drive train such as a gear train, and serves as a driving source that supplies driving force for driving the photosensitive drum 1. The motor M1 of the present embodiment also serves as a driving source that rotationally drives the fixing portion 74 and rollers (the pickup roller 82, the feed rollers 84 and 89, the registration roller pair 88, and the like) related to the conveyance of the sheet S.

### Lubricating Layer

Next, a lubricating layer formed at a contact portion between the cleaning blade 6 and the photosensitive drum 1 will be described. FIG. 2 is a schematic view illustrating an enlarged cross-section of the blade nip 6N, which is a contact portion where the edge portion 6c of the cleaning blade 6 and a surface, i.e., outer circumference surface, of the photosensitive drum 1 come into contact.

At the blade nip 6N, the edge portion 6c of the cleaning blade 6 receives frictional force from the rotating photosensitive drum 1. If the frictional force is large, turning-up or chipping of the cleaning blade 6, i.e., turning-up or chipping of the rubber blade, occurs, and toner may pass through the blade nip 6N.

An assembly in which external additives contained in toner are accumulated, hereinafter referred to as a lubricating layer 6a, is formed at the blade nip 6N. The lubricating layer 6a is formed on an upstream side in a direction of rotation of the photosensitive drum 1, i.e., arrow direction in the drawing, with respect to a contact area of the cleaning blade 6 and the photosensitive drum 1 at the blade nip 6N. The lubricating layer 6a includes fine particles contained as external additives in toner. Examples of external additives that form the lubricating layer 6a are inorganic silica particles and organic silicon polymer particles, but are not limited thereto. In the present embodiment, the lubricating layer 6a is described as being formed mainly of fine particles of external additives having a smaller mean particle size than toner particles T, but substances other than external additive, such as toner particles T accumulated at the blade nip 6N, may also be included in the lubricating layer 6a.

The presence of the lubricating layer 6a improves the sliding performance of the cleaning blade 6 on the surface 1a of the photosensitive drum 1. Therefore, the lubricating layer 6a may reduce the turning-up or chipping of the cleaning blade 6 and reduce the passing through of toner. The lubricating layer 6a may be referred to as a blocking layer, i.e., barrier layer, that blocks toner from passing through.

As described, the lubricating layer 6a contributes to maintaining and improving the cleaning performance. When the lubricating layer 6a runs out, the turning-up or chipping of the cleaning blade 6 and the passing through of toner caused thereby may occur. Toner having passed through the blade nip 6N may be accumulated on the charging roller 2 and cause charging failures.

### Toner Purge Operation

A toner purge operation of the image forming apparatus 100 will be described. Toner purge operation is an operation, i.e., toner supplying operation, in which a predetermined toner image, i.e., toner pattern, formed on the surface 1a of the photosensitive drum 1 passes through the transfer portion and toner is supplied to the blade nip 6N, which is the contact portion of the cleaning blade 6 and the photosensitive drum 1. By executing the toner purge operation when no image is being formed, the control unit B1 can supply toner to the blade nip 6N and prevent depletion of the lubricating layer 6a.

In the toner purge operation, similar to a normal image forming operation, after the surface of the rotating photosensitive drum 1 is charged by the charging roller 2, the photosensitive drum 1 is exposed by the scanner unit 3, and a latent image is formed on the surface of the photosensitive drum 1. The latent image is developed by having toner supplied from the developing roller 25, and a toner image of a predetermined pattern is formed on the surface of the photosensitive drum 1. The toner image of a predetermined pattern passes through the transfer nip N without being transferred to the sheet S, and reaches the blade nip 6N.

In the toner purge operation, the predetermined toner image formed of a predetermined pattern, hereinafter referred to as a toner pattern, is formed to have a density and shape set in advance, unlike the latent image formed in the image forming operation based on the image information. The information designating the density and shape of the toner pattern may set to be stored in advance in the storage unit within the control unit B1.

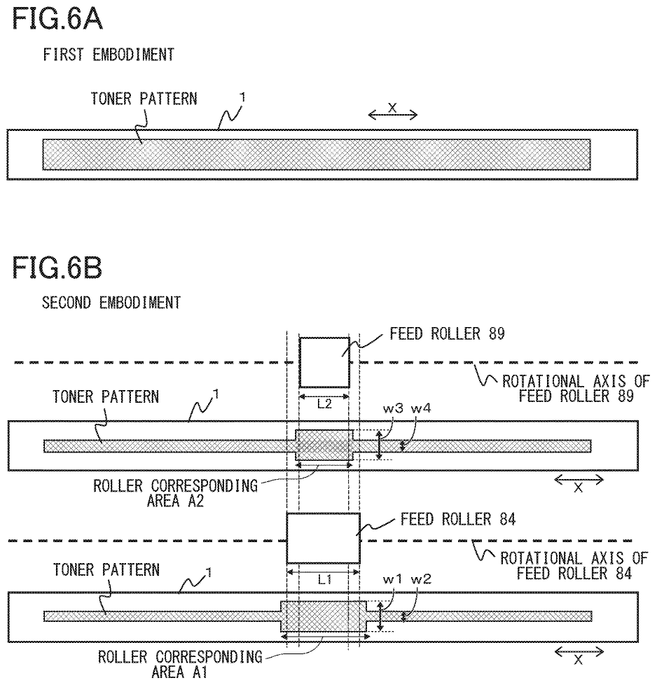

The toner pattern according to the present embodiment is a uniform toner image having a highest density formable by the image forming portion 102, i.e., solid image. Further, the toner pattern according to the present embodiment has a rectangular shape (see FIG. 6A) extending in a rotational axis direction X of the photosensitive drum 1, i.e., main scanning direction during forming of image. That is, the toner pattern according to the present embodiment has a rectangular shape extending in the rotational axis direction X of the photosensitive drum 1 in a state where the surface 1a of the photosensitive drum 1 is developed in a plane.

A length of the toner pattern in the sub-scanning direction of the photosensitive drum 1, i.e., circumference surface direction of the photosensitive drum 1, is referred to as a width of the toner pattern. Further, a total amount of toner of the toner pattern formed on the photosensitive drum 1 by a toner purge operation is referred to as a “toner purge amount”.

When the toner image passes through the transfer nip N in the toner purge operation, a bias voltage of an opposite polarity as that of the transfer voltage during forming of image is applied to the transfer roller 69. For example, in a case where a normal charge polarity of toner is a negative polarity, the transfer voltage during forming of image has a positive polarity, and the bias voltage applied to the transfer roller 69 in the toner purge operation has a negative polarity. Therefore, the toner pattern formed of toner charged to negative polarity passes through the transfer nip N without being transferred to the transfer roller 69 and reaches the blade nip 6N.

The expression “when image is not formed” basically refers to a timing other than during execution of image forming operation. For example, in a case where the control unit B1 (FIG. 3) of the image forming apparatus 100 receives an image forming instruction from the user, the control unit B1 executes an image forming job, hereinafter sometimes simply referred to as job, including the aforementioned image forming operation. The image forming job is a series of tasks including an image forming operation executed repeatedly to the number of sheets S designated by the user, a pre-rotation operation, which is a preparation operation of the image forming operation, and a post-rotation operation, which is an adjustment operation executed after the image forming operation. In the post-rotation operation, even after the last image forming operation during a job has ended, the rotation of the photosensitive drum 1 is continued for a predetermined period of time, while adjustments such as a shutdown processing of various bias voltages, i.e., stopping of voltage output, and cooling of the fixing portion 74 are performed.

The expression “when image is not formed” may include during execution of the post-rotation operation, during execution of the pre-rotation operation, and a period from execution of the previous image forming operation to the execution of a subsequent image forming operation within one job, i.e., so-called sheet interval. In the present embodiment, the toner purge operation is executed during execution of the post-rotation operation, i.e., during post-rotation. In other words, upon receiving an image forming job from the user, the control unit B1 executes the toner supplying operation during a period of time after the transfer of the toner image has been performed to all the number of sheets designated by the user and before the rotational driving of the photosensitive drum 1 is stopped.

In the image forming apparatus 100, there may be a case where a portion of the image forming operation and a portion of the operation when image is not formed overlap on a timeline. Therefore, “when image is not formed” is described based on a timing at which a point being focused on the surface 1a of the photosensitive drum 1 passes through the transfer nip N. For example, a case is assumed where the last sheet S of a job has not yet passed through the transfer nip N at a point of time when the scanner unit 3 started exposing the photosensitive drum 1 to form a toner pattern for the toner purge operation. Even in such a case, if exposure is started at a timing at which the leading edge of the toner pattern reaches the transfer nip N after the last sheet S has passed through the transfer nip N, it can be stated that the toner purge operation is executed when image is not formed, i.e., during post-rotation.

### Influence of Paper Dust

Next, the depletion and reformation of the lubricating layer 6a, and influence of paper dust will be described. Along with the rotation of the photosensitive drum 1, external additives leak through the blade nip 6N little by little, such that the lubricating layer 6a is gradually reduced during execution of the image forming operation. If the image forming operation is executed in a state where the lubricating layer 6a is reduced, turning-up or chipping of the cleaning blade 6 may occur, and passing through of toner may occur. For example, after the photosensitive drum 1 has been stopped in a state where the lubricating layer 6a is reduced by the image forming operation performed during the previous job, if a subsequent image forming job is entered and the rotation of the photosensitive drum 1 is started, turning-up or chipping of the cleaning blade 6 tend to occur. A state in which the turning-up or chipping of the cleaning blade 6 tends to occur by the reduction of the lubricating layer 6a may be referred to as a state in which the lubricating layer 6a has been depleted.

By executing the toner purge operation when image is not formed, toner and external additives may be supplied to the blade nip 6N, and the lubricating layer 6a may be reformed. Thereby, the passing through of toner may be suppressed, and a stable cleaning performance may be maintained for a long period of time. Specifically, by executing the toner purge operation during post-rotation, a state in which the lubricating layer 6a is depleted at the time the driving of the photosensitive drum 1 is started after a subsequent image forming job has been entered may be prevented, such that the passing through of toner may be suppressed more effectively.

However, if the cleaning performance is maintained within a permissible range, it may be preferable that the amount of toner consumed by the toner purge operation is as little as possible. As the amount of toner consumed by the toner purge operation increases, the ratio of toner among the toner stored in the toner storage chamber 31a that is consumed without being used for image formation also increases. Therefore, as the amount of toner consumed by the toner purge operation increases, the accumulated number of sheets on which image can be output by the image forming apparatus 100, i.e., printable number of sheets, from the time the process cartridge 70 has been exchanged to the depletion of toner within the process cartridge 70 decreases. Further, even if an excessive amount of toner has been supplied during the toner purge operation, there is a limit in the amount of external additives to be maintained at the blade nip 6N as the lubricating layer 6a, such that the period of time until the lubricating layer 6a is depleted will not be extended.

### Deterioration of Cleaning Performance by Paper Dust

As described above, when forming images, the lubricating layer 6a is gradually reduced, but specifically, the depletion of the lubricating layer 6a may be advanced by the influence of paper dust. Paper dust is foreign matter that is generated from the sheets S used as recording material and mainly attached to the photosensitive drum 1 at the transfer nip N. Paper dust includes paper fiber and/or filler.

The present inventors have discovered that even if the toner purge operation is executed when image is not formed, excess or deficiency of toner supplied to the blade nip 6N, which is the contact portion of the cleaning member and the photosensitive drum, may occur, depending on the condition of the image forming operation, hereinafter referred to as image forming condition. Further, the present inventors have also discovered that the excess or deficiency of toner supplied to the contact portion, i.e., the blade nip 6N, may cause decrease of the printable number of sheets due to excessive toner consumption, or deterioration of cleaning performance by depletion of the lubricating layer.

More specifically, if paper dust attached to the photosensitive drum 1 enters the blade nip 6N, the reduction of the lubricating layer 6a advances compared to a state where paper dust has not entered thereto. It is considered that a portion of the external additives of the lubricating layer 6a passes through the blade nip 6N by being pushed by the paper dust that moves in the direction of rotation of the photosensitive drum 1 together with the surface 1a of the photosensitive drum 1. Therefore, when the image forming operation is executed under an image forming condition where a large amount of paper dust is generated, the pace of reduction of the lubricating layer 6a is advanced even if the number of image forming operations is the same compared to a case where the image forming operation is executed under an image forming condition with less paper dust.

The image forming condition may include designation of cassette or tray serving as a supply source of the sheet S used for image formation, attributes of the sheet S such as material, size, and grammage, designation of simplex or duplex printing, and an average image cover of the image being output.

### Paper Dust Generation Mechanism

Among the image forming conditions, the first embodiment focuses on the amount of paper dust generated at the time of image formation that varies according to the difference of conveyance paths of the sheet S. Specifically, the first embodiment illustrates changing execution conditions of the toner purge operation according to the difference in supply sources of the sheet S.

The reason why the amount of paper dust varies according to the difference in supply sources of the sheet S will be described with reference to FIG. 4. FIG. 4 is a schematic diagram illustrating a portion of the image forming apparatus 100 according to the present embodiment equipped with the sheet cassette 80 and the manual feed tray 81 that serve as the plurality of supply sources of the sheet S.

A path through which the sheet S is conveyed from the sheet cassette 80 toward the transfer nip N is referred to as the first conveyance path P1 or a cassette sheet feed path. A path through which the sheet S is conveyed from the manual feed tray 81 toward the transfer nip N is referred to as the second conveyance path P2 or a manual sheet feed path. The first conveyance path P1 and the second conveyance path P2 may be partially overlapped. In the present embodiment, the first conveyance path P1 and the second conveyance path P2 are overlapped in the section from the registration roller pair 88 to the transfer nip N.

The first conveyance path P1, i.e., cassette sheet feed path, is curved relatively steeply. According to the illustrated configuration example, at least in the section between the feed roller 84 and the relay roller pair 85, the conveyance path formed between the conveyance guides 91 and 92 is curved most steeply. A relatively large amount of paper dust may be generated when the sheet S is conveyed while being rubbed against the conveyance guides 91 or 92 at the curved portion of the first conveyance path P1.

Meanwhile, the second conveyance path P2, i.e. manual sheet feed path, is either straight or curved gently compared to the first conveyance path P1. Therefore, the contact of the sheet S with the conveyance guides 93 or 94 is relatively weak, and paper dust is less likely to be generated compared to the first conveyance path P1.

When the sheet S is conveyed along the curved conveyance path, for example, a leading edge portion of the sheet S, that is, downstream edge of the sheet in the sheet conveyance direction, rubs against the surface of the conveyance guide and receives frictional force. The conveyance guides 91 to 94 are formed of a resin material, such as a polycarbonate resin, an ABS resin, or a PC+ABS resin. In the present embodiment, PC+ABS resin is used. The stronger the sheet S rubs against the conveyance guide, the more the smoothness of the sheet surface is lost at the rubbed portion, and a state occurs where fiber or filler is easily separated from the surface of the sheet S. Therefore, the amount of generation of paper dust increases as the sheet S is rubbed more strongly against the conveyance guide.

Further, the frictional force that the sheet S receives from the roller becomes stronger as the speed difference between a speed of movement of the sheet S and a circumference surface speed of the roller coming into contact with the sheet S, such as the feed rollers 84 and 89 or the registration roller pair, increases. In the case where the frictional force that the sheet S receives from the roller is strong, the amount of generation of paper dust also tends to increase.

Further, the frictional charging of the sheet S occurs more easily by being rubbed against the conveyance guide or the rollers as the frictional force that the sheet S receives from the conveyance guide or the rollers increases. If the sheet S passes through the transfer nip Nin a state where the charged amount of the sheet S is high, a part of the paper dust may be attracted to the photosensitive drum 1 electrostatically by a potential difference between the transfer roller 69 to which the transfer voltage is applied and the surface potential of the photosensitive drum 1.

Due to such reasons, when the image forming operation to the sheet S fed via the first conveyance path P1 is performed, a greater amount of paper dust tends to occur compared to a case where the image forming operation to the sheet S fed via the second conveyance path P2 is performed.

Therefore, according to the present embodiment, a toner purge amount, i.e., first toner amount, in a case where the sheet S is fed via the first conveyance path P1 in the image forming operation is set greater than a toner purge amount, i.e., second toner amount, in a case where the sheet S is fed via the second conveyance path P2 in the image forming operation. In other words, the toner purge amount is varied depending on whether the supply source of the sheet S used for the image forming operation is the sheet cassette 80, i.e., first supporting portion, or the manual feed tray 81, i.e., second supporting portion.

Thereby, a more appropriate amount of toner corresponding to the difference in the amount of generation of paper dust due to the difference in the conveyance paths may be supplied to the blade nip 6N, i.e., contact portion.

More specifically, if the sheet S passes through either of two conveyance paths having different radii of curvature at a same speed, the frictional force applied to the sheet S per unit time has a negative correlation with a minimum radius of curvature of the conveyance path. That is, the amount of generation of paper dust can be estimated based on the minimum radius of curvature of the conveyance path.

In a state where the photosensitive drum 1 is viewed in the rotational axis direction X, a minimum value of a radius of curvature of a guide surface, i.e., surface facing the conveyance guide positioned on the outer side of a curved portion, of the conveyance guide positioned on an inner side of the curved portion of the first conveyance path P1 is defined as a minimum radius of curvature R1 of the first conveyance path P1. Similarly, in a state where the photosensitive drum 1 is viewed in the rotational axis direction X, a minimum value of a radius of curvature of a guide surface, i.e., surface facing the conveyance guide positioned on the outer side of a curved portion, of the conveyance guide positioned on an inner side of the curved portion of the second conveyance path P2 is defined as a minimum radius of curvature R2 of the second conveyance path P2. The minimum radius of curvature R1 represents a degree of curvature of the most steeply curved portion of the first conveyance path P1, and the minimum radius of curvature R2 represents a degree of curvature of the most steeply curved portion of the second conveyance path P2.

According to the present embodiment, a conveyance guide 92, i.e., first conveyance guide, is positioned on an inner side of the curved portion of the first conveyance path P1. The minimum radius of curvature R1 of the first conveyance path P1 is a minimum value of radius of curvature of a surface, i.e., guide surface that guides the sheet S, of the conveyance guide 92, i.e., first conveyance guide, when the photosensitive drum 1 is viewed in the rotational axis direction X. Further according to the present embodiment, a conveyance guide 94, i.e., second conveyance guide, is positioned on an inner side of the curved portion of the second conveyance path P2. The minimum radius of curvature R2 of the second conveyance path P2 is a minimum value of radius of curvature of a surface, i.e., guide surface that guides the sheet S, of the conveyance guide 94, i.e., second conveyance guide, when the photosensitive drum 1 is viewed in the rotational axis direction X.

According to the present embodiment, the minimum radius of curvature R1 of the first conveyance path P1 is smaller than the minimum radius of curvature R2 of the second conveyance path P2, i.e., R1<R2. That is, a portion of the first conveyance path P1 curved most steeply is curved more steeply than the portion of the second conveyance path P2 curved most steeply. The minimum radius of curvature R1 is 50 mm, and R2 is 300 mm, for example.

It can be considered that each reciprocal of the minimum radius of curvatures R1 and R2 of the conveyance paths is approximately proportional to the amount of paper dust generated when the sheet S is conveyed through each conveyance path. Therefore, according to the present embodiment, the reciprocal of each of the minimum radius of curvatures R1 and R² is used as a numerical value for determining an execution condition of the toner purge operation, which is referred to as a determination value of the toner purge amount, or simply, a determination value.

Determination value=1/minimum radius of curvature of conveyance path (mm) (Expression 1)

In a case where the determination value described above exceeds a threshold value set in advance, the amount of toner to be supplied to the blade nip 6N by the toner purge operation is set greater than the amount of toner to be supplied to the blade nip 6N by the toner purge operation in a case where the determination value is equal to or smaller than the threshold value. The threshold value is set, for example, to 0.01.

The control unit B1 changes the amount of toner to be supplied to the blade nip 6N, i.e., contact portion, by the toner purge operation, i.e., toner supplying operation, by changing the width of the toner pattern, i.e., predetermined toner image, in the direction of rotation of the photosensitive drum 1. More specifically, in a case where the control unit B1 determines that the determination value of the toner purge amount is greater than the threshold value, the width of the toner pattern in the toner purge operation executed during post-rotation of the job is set to 10 mm. Meanwhile, in a case where the control unit B1 determines that the determination value is equal to or smaller than the threshold value, the width of the toner pattern in the toner purge operation executed during post-rotation of the job is set to 5 mm.

Therefore, in a case where the sheet cassette 80 is set as the supply source of the sheet S, the determination value (1/50) exceeds the threshold value (0.01), such that a 10-mm-width toner pattern is formed in the toner purge operation during post-rotation. Meanwhile, in a case where the manual feed tray 81 is set as the supply source of the sheet S, the determination value (1/300) is equal to or lower than the threshold value (0.01), such that a 5-mm-width toner pattern is formed in the toner purge operation. That is, the amount of toner to be supplied to the blade nip 6N in the toner purge operation is increased in a case where the sheet S is fed from the sheet cassette 80 than in a case where the sheet S is fed from the manual feed tray 81.

As described, when image formation is performed to the sheet S conveyed via the first conveyance path P1 that has a tendency to generate a greater amount of paper dust, the amount of toner to be supplied to the blade nip 6N by the toner purge operation is increased. Thereby, even if a greater amount of paper dust enters the blade nip 6N, depletion of the lubricating layer 6a can be suppressed. Further, when image formation is performed to the sheet S conveyed via the second conveyance path P2 where paper dust is less likely to occur, the amount of toner to be supplied to the blade nip 6N by the toner purge operation is reduced. Thereby, the amount of toner consumed by the toner purge operation may be reduced while suppressing the deterioration of cleaning performance.

In other words, in a case where the toner supplying operation is executed after performing the image forming operation to a sheet conveyed via the first conveyance path P1 to the transfer portion, an amount of toner to be supplied to the contact portion by the toner supplying operation is set to a first toner purge amount, i.e., first toner amount. In a case where the toner supplying operation is executed after performing the image forming operation to a sheet conveyed via the second conveyance path P2 to the transfer portion, an amount of toner to be supplied to the contact portion by the toner supplying operation is set to a second toner purge amount, i.e., second toner amount. In this case, the control unit B1 according to the present embodiment sets the first toner purge amount, i.e., first toner amount, to be greater than the second toner purge amount, i.e., second toner amount. Thereby, the amount of toner consumed by the toner purge operation can be reduced while suppressing the deterioration of cleaning performance.

### Control Flow

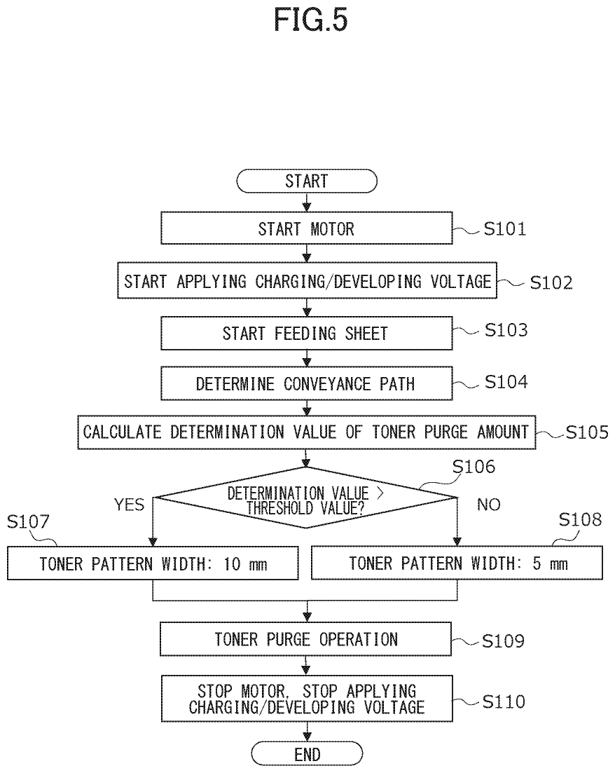

FIG. 5 is a flowchart illustrating an example of an execution sequence of an image forming job according to the first embodiment. The respective steps of the present flowchart are performed by the CPU of the control unit B1 (FIG. 3) executing a program read from the storage unit.

When an image forming job is entered by a user, the control unit B1 starts the present sequence based on the received image information and job information. The job information is information related to a designation of image forming condition that the user has selected when entering the job. The user can set the job information through an operation panel provided in the image forming apparatus 100 or by operating a driver software screen of an external device connected to the image forming apparatus 100.

In S101, the control unit B1 starts the motor M1 (FIG. 3), by which the rotation of the photosensitive drum 1 is started. In S102, the control unit B1 executes a start processing, i.e., application start processing, of various bias voltages. Thereby, for example, a charging voltage of −1100 V is applied to the charging roller 2, and a developing voltage of −400 V is applied to the developing roller 25.

In S103, the control unit B1 starts to feed the sheet S from a supply source, i.e., the sheet cassette 80 or the manual feed tray 81, designated in the job information. In other words, the control unit B1 starts the feeding operation by the pickup roller 82 and the feed roller 84 of the cassette sheet feed portion F1, or starts the feeding operation by the feed roller 89 of the manual sheet feed portion F2.

In S104, the control unit B1 determines the conveyance path of the sheet S. That is, whether the image forming operation is performed to the sheet S conveyed via the first conveyance path P1 from the sheet cassette 80 or the image forming operation is performed to the sheet S conveyed via the second conveyance path P2 from the manual feed tray 81 in the present job is determined.

In S105, the control unit B1 calculates the determination value of the toner purge amount using Expression (1) based on the detection result of S104, and in S106, compares the determination value with the threshold value. If it is determined in S106 that the determination value is greater than the threshold value, the control unit B1 sets the toner pattern width of the toner purge operation to 10 mm in S107. Meanwhile, if it is determined in S106 that the determination value is equal to or smaller than the threshold value, the control unit B1 sets the toner pattern width of the toner purge operation to 5 mm in S108.

In S109, the control unit B1 executes the toner purge operation during post-rotation in the present job. In this state, a toner pattern is formed according to a toner purge amount, i.e., toner pattern width, set in S107 or S108, and toner is supplied to the blade nip 6N.

In S110, the control unit B1 stops application of the charging voltage and the developing voltage, and after stopping the rotation of the motor M1, ends the image forming job sequence. Rotation of the motor M1 is stopped at a timing after the entire toner pattern formed by the toner purge operation has arrived at the blade nip 6N.

### Evaluation Experiment 1

An experiment described below was performed to evaluate a cleaning performance and a toner consumption amount according to the configuration of the present embodiment. Comparative examples 1 and 2 in which the toner purge amount in the toner purge operation is set to a fixed value regardless of the conveyance path of the sheet S were prepared. In comparative example 1, the toner pattern width was fixed to 7.5 mm, and in comparative example 2, the toner pattern width was fixed to 10 mm.

According to the first embodiment, the toner pattern width in the toner purge operation performed after the image forming operation in which the sheet S is fed through the first conveyance path P1, i.e., cassette sheet feed path, in an intermittent printing operation is 10 mm. Further according to the first embodiment, the toner pattern width in the toner purge operation performed after the image forming operation in which the sheet S is fed through the second conveyance path P2, i.e., manual sheet feed path, in an intermittent printing operation is 5 mm.

Evaluation of cleaning performance was performed by confirming whether image defects called vertical stripes have occurred after intermittent printing operation in which test sheets are fed alternately through the first conveyance path P1, i.e., the sheet cassette 80, and the second conveyance path P2, i.e., the manual feed tray 81. The condition of experiment was an environment of 23° C. and 50%. Through intermittent printing operation, a test image having an image coverage of 2% was formed to a total of 30K, or 30000, test sheets. K represents×1000. That is, 1000 sheets equals 1K sheets, and this unit may be used in the following description. During execution of the intermittent printing operation, each time an image forming operation to one sheet S is finished, the toner purge operation was executed according to the toner pattern widths of the first embodiment or comparative example 1 or 2. A Red Label Presentation, which is manufactured by Canon, Inc., having a grammage of 80 g/m² was used as the sheet S. After performing the intermittent printing operation, a halftone image having an image coverage of 25% was output, and presence of vertical stripes within the halftone image was confirmed. Vertical stripes refer to unevenness of density that extends in a conveyance direction, i.e., sub-scanning direction during image formation, of the sheet S. In Table 1 illustrated below, “Good” indicates that vertical stripes did not occur, and “Poor” indicates that vertical stripes have occurred, i.e., vertical stripes of a level that is recognized as a problem regarding image quality have been visually confirmed.

The evaluation of toner consumption amount was performed by filling the toner storage chamber 31a with a predetermined amount of toner, repeatedly forming a predetermined test image, and recording an accumulated number of printed sheets before a void occurs in the image caused by depletion of toner as “number of sheets before occurrence of void”. The void in an image refers to image defects in which a part of the halftone toner image is missing and a white void area has been formed.

Table 1 shows the setting of toner purge amount, i.e., toner pattern width in the toner purge operation according to comparative examples 1 and 2 and the first embodiment, and evaluation results of cleaning performance and toner consumption amount, i.e., number of sheets before occurrence of void.

TABLE 1

| | COMPARATIVE | COMPARATIVE | FIRST |
|---|---|---|---|
| | EXAMPLE 1 | EXAMPLE 2 | EMBODIMENT |
| TONER PURGE AMOUNT | 7.5 mm | 10 mm | 5 mm/10 mm |
| (TONER PATTERN WIDTH) | | | |
| EVALUATION OF CLEANING | Poor | Good | Good |
| PERFORMANCE: | | | |
| PRESENCE OF VERTICAL STRIPES | | | |
| EVALUATION OF TONER | 41 | 36 | 41 |
| CONSUMPTION AMOUNT: | | | |
| NUMBER OF SHEETS BEFORE | | | |
| OCCURRENCE OF VOID | | | |
| (1000 SHEETS) | | | |

As illustrated in Table 1, according to the comparative example 1, the evaluation of cleaning performance was “Poor”. This is considered to be caused by the reformation of the lubricating layer 6a being insufficient during the execution of the image formation operation under a condition where a large amount of paper dust is generated in a case where the toner pattern width in the toner purge operation is fixed to 7.5 mm.

For example, in a case where the sheet S is fed through the first conveyance path P1, i.e., cassette sheet feed path, in intermittent printing operation, a relatively large amount of paper dust is generated. In this case, the reduction of the lubricating layer 6a is advanced by the influence of paper dust, such that even if a toner pattern having a width of 7.5 mm is supplied to the blade nip 6N by toner purge operation, reformation of the lubricating layer 6a may be insufficient, and the deterioration of the cleaning performance cannot be suppressed. For example, during execution of the intermittent printing operation, when a subsequent image forming operation is started in a state where the lubricating layer 6a is insufficient, the cleaning blade may be turning-up or chipped, by which paper dust and external additives of toner may pass through the cleaning blade 6. Then, paper dust and external additives of toner are accumulated along the circumferential direction of the charging roller 2. As a result, vertical stripes caused by charging failure are considered to have occurred on the halftone image after performing intermittent printing operation to 30K sheets.

Further, since the deterioration of cleaning performance was similarly generated according to comparative example 1, the deterioration of cleaning performance will clearly become even more significant, i.e., the evaluation of cleaning performance will be “Poor”, if the toner pattern width is fixed to 5 mm.

In comparative example 2, even though the evaluation of cleaning performance was “Good”, the number of sheets before occurrence of void was reduced from 41K sheets of comparative example 1 to 36K sheets. This means that even during conveyance of sheets through the first conveyance path P1, i.e., cassette sheet feed path, according to which a large amount of paper dust is generated, if the toner pattern having a width of 10 mm is supplied to the blade nip 6N by toner purge operation, the deterioration of cleaning performance could be suppressed. Meanwhile, even during conveyance of sheets through the second conveyance path P2, i.e., manual sheet feed path, where less paper dust is generated, toner corresponding to a toner pattern having a 10-mm width will be constantly consumed by the toner purge operation. That is, toner is not used for the image forming operation but consumed in a state not contributing to the maintenance of cleaning performance. As a result, in comparative example 2, the number of sheets before occurrence of void was reduced compared to comparative example 1.

In contrast, according to the first embodiment, the evaluation of cleaning performance was “Good”, and the number of sheets before occurrence of void was 41K sheets, equivalent to the comparative example 1.

According to the first embodiment, in the toner purge operation after the image forming operation in which the sheet S is fed through the first conveyance path P1, i.e., cassette sheet feed path, a 10-mm-width toner pattern is supplied to the blade nip 6N by toner purge operation. Therefore, it is considered that, similar to comparative example 2, even during sheet conveyance through the first conveyance path P1, i.e., cassette sheet feed path, in which a large amount of paper dust is generated, the lubricating layer 6a was maintained, and the deterioration of cleaning performance was suppressed. It is considered that in the toner purge operation after the image forming operation in which the sheet S is fed through the second conveyance path P2, i.e., manual sheet feed path, in which a small amount of paper dust is generated, a sufficient lubricating layer 6a could be maintained even by supplying a toner pattern having a 5-mm width, and the cleaning performance was maintained.

That is, according to the first embodiment, the deterioration of cleaning performance by depletion of the lubricating layer 6a can be prevented.

According further to the first embodiment, compared to comparative example 2, the amount of toner consumption by the toner purge operation after the image forming operation in which the sheet S is fed through the second conveyance path P2, i.e., manual sheet feed path, was small. That is, according to the first embodiment, toner consumption that is not used for the image forming operation and that does not contribute to the maintenance of the cleaning performance is suppressed. As a result, according to the first embodiment, the number of sheets before occurrence of void, that is, the number of sheets on which image can be output by the image forming apparatus 100 before the toner of the toner storage chamber 31a is depleted, was improved compared to the comparative example 2.

That is, according to the first embodiment, the reduction of the printable number of sheets caused by excessive toner consumption by the toner purge operation can be prevented.

Further, when the first embodiment and the comparative example 1 are compared, even though the accumulated toner consumption amounts by the toner purge operation executed during the period of intermittent printing operation were approximately the same, according to the first embodiment, the deterioration of cleaning performance was suppressed compared to comparative example 1. This means that by changing the toner purge amount according to the difference in conveyance paths, toner can be utilized more effectively for image formation and for maintaining the cleaning performance.

That is, according to comparative example 1, the toner purge amount is insufficient when sheets are fed through the first conveyance path P1, i.e., cassette sheet feed path, and the toner purge amount is excessive when sheets are fed through the second conveyance path P2, i.e., manual sheet feed path. According to the first embodiment, the lack of toner purge amount when sheets are fed through the first conveyance path P1 in comparative example 1 is compensated using the excessive part of the toner purge amount when sheets are fed through the second conveyance path P2 in comparative example 1.

As described, according to the first embodiment, the reduction of printable number of sheets through excessive toner consumption by the toner purge operation can be suppressed, while the deterioration of cleaning performance by depletion of the lubricating layer 6a can also be suppressed.

### SUMMARY OF PRESENT EMBODIMENT

A lubricating layer by external additives of toner is formed at the contact portion between the cleaning member and the photosensitive drum. The lubricating layer contributes to enhancing the cleaning performance by improving the lubricating ability of the cleaning member and suppressing the passing through of toner.

However, even if an operation to supply toner to the contact portion between the cleaning member and the photosensitive drum is performed when image is not formed to prevent depletion of the lubricating layer, excess or deficiency of toner supplied to the contact portion may still occur depending on the conditions of the image forming operation.

As described above, according to the present embodiment, the toner purge amount of the toner purge operation, i.e., toner supplying operation, is changed according to the conveyance paths of the sheet S during image formation. In other words, the control unit B1 changes the amount of toner to be supplied to the contact portion by the toner supplying operation between a case where the toner supplying operation is executed after the image forming operation to a sheet conveyed to the transfer portion via the first conveyance path P1 and a case where the toner supplying operation is executed after the image forming operation to a sheet conveyed to the transfer portion via the second conveyance path P2 that differs from the first conveyance path P1.

Thereby, an image forming apparatus capable of supplying a more appropriate amount of toner to the contact portion between the cleaning member and the photosensitive drum can be provided.

According further to the present embodiment, the toner purge amount after the image forming operation to the sheet S conveyed via the first conveyance path P1 that is curved in a U shape is greater than the toner purge amount after the image forming operation to the sheet S conveyed via the second conveyance path P2. Therefore, an image forming apparatus capable of supplying a more appropriate amount of toner while suppressing the influence of paper dust that is generated in the first conveyance path P1 curved in a U shape can be provided.

According further to the present embodiment, the toner purge amount after the image forming operation to the sheet S conveyed via the first conveyance path P1 that has a smaller minimum radius of curvature R1 is greater than the toner purge amount after the image forming operation to the sheet S conveyed via the second conveyance path P2 having a greater minimum radius of curvature R2. Therefore, an image forming apparatus capable of supplying a more appropriate amount of toner while suppressing the influence of paper dust that is generated in the first conveyance path P1 curved in a U shape can be provided.

### Modified Example

In the first embodiment, an example of determining the toner purge amount in the toner purge operation by comparing the determination value of the toner purge amount calculated according to conveyance paths with the threshold value was described. However, the actual method for changing the toner purge amount according to the different conveyance paths is not limited thereto. For example, toner purge amounts for each of the conveyance paths provided in the image forming apparatus may be determined in advance, and the corresponding relationships between the conveyance paths and the toner purge amounts may be stored in the storage unit of the control unit B1. In this case, it may be possible to omit the determination value calculation step (S105) and the comparison step with the threshold value (S106) in the flow of FIG. 5, and to determine the toner purge amount directly based on the determination result of S104 (S107 and S108).

In the case where a determination value of the toner purge amount is used, the method for calculating the determination value is not limited to that described in the first embodiment (refer to Expression (1)). For example, a value obtained by applying an arithmetic operation using a coefficient considering the image forming conditions other than conveyance paths to the value on the right side of Expression (1) may be set as the determination value. Image forming conditions being considered may be, for example, accumulated number of printed sheets from the previous toner purge operation, and environmental conditions, i.e., temperature and/or humidity, in the circumference of the image forming apparatus during execution of the image forming job. For example, a coefficient corresponding to the accumulated number of printed sheets may be added to the value on the right side of Expression (1) such that the determination value of the toner purge amount increases as the accumulated number of printed sheets increases. Further, a coefficient corresponding to the environmental temperature may be added to the value on the right side of Expression (1) such that the determination value of the toner purge amount increases as the environmental temperature decreases.

The method for changing the toner purge amount is not limited to changing the toner pattern width in the direction of rotation of the photosensitive drum 1, and it may be performed by changing the toner pattern density, i.e., amount of toner per unit area on the surface 1a of the photosensitive drum 1. Further, in a case where a plurality of parallel lines aligned in the rotational axis direction X of the photosensitive drum 1 and also aligned in the direction of rotation of the photosensitive drum 1 are used as a toner pattern, the number of lines of the parallel lines may be changed.

In the first embodiment, a case where the toner purge amount is changed in two steps to a 5-mm width and a 10-mm width has been described, but it is also possible to change the toner purge amount in three or more steps using a plurality of threshold values. Further, the method is not limited to the method of selecting a toner purge amount from steps set in advance, and a configuration may be adopted in which a toner purge amount is determined according to the image forming condition, such that the toner purge amount takes an arbitrary value within a successive numerical range.

In the first embodiment, an example in which the toner purge operation is executed during post-rotation has been described, but the toner purge operation may also be executed when image is not formed and at a timing other than the post-rotation operation. For example, in a continuous image forming job in which a plurality of sheets S are continuously conveyed while having images formed thereon, the toner purge operation may be executed at a final sheet interval of the job, that is, a sheet interval that occurs immediately before transferring the last toner image of a job. According to this configuration, similar to the case in which a toner purge operation is executed during post-rotation, the lubricating layer 6a can be reformed before a point of time when the current job ends. Therefore, the turning-up or chipping of the cleaning blade 6 when the rotation of the photosensitive drum 1 is started when a subsequent job is entered may be suppressed effectively, such that advantages similar to those of the embodiment described above may be achieved.

### Second Embodiment

A configuration in which a shape of a toner pattern in the toner purge operation differs from the first embodiment will be described as the second embodiment. Hereinafter, components assigned with the same reference numbers as the first embodiment have basically the same configuration and same effect as those described in the first embodiment unless denoted otherwise, and portions that differ from the first embodiment will mainly be described below.

FIGS. 6A and 6B are each a schematic diagram illustrating a shape of a toner pattern formed by a toner purge operation. FIG. 6A illustrates a toner pattern used in the first embodiment. FIG. 6B illustrates a toner pattern used in the second embodiment. An upper part of FIG. 6B illustrates a toner pattern used in the toner purge operation executed after executing the image forming operation to the sheet S fed via the first conveyance path P1, i.e., cassette sheet feed path. A lower part of FIG. 6B illustrates a toner pattern used in the toner purge operation executed after executing the image forming operation to the sheet S fed via the second conveyance path P2, i.e., manual sheet feed path.

As illustrated in FIG. 6A, according to the first embodiment, the toner pattern width in the direction of rotation of the photosensitive drum 1, i.e., sub-scanning direction, or drum circumferential direction, is fixed regardless of the position in the rotational axis direction X of the photosensitive drum 1. Meanwhile, as illustrated in FIG. 6B, according to the second embodiment, the toner pattern width differs according to the position in the rotational axis direction X of the photosensitive drum 1.

Specifically, according to the second embodiment, a toner pattern width w1 in an area corresponding to the feed roller 84 of the cassette sheet feed portion F1, hereinafter referred to as a roller corresponding area A1, is greater than a toner pattern width w2 in the area other than the roller corresponding area A1. Further according to the second embodiment, a toner pattern width w3 in an area corresponding to the feed roller 89 of the manual sheet feed portion F2, hereinafter referred to as a roller corresponding area A2, is greater than a toner pattern width w4 in the area other than the roller corresponding area A2.

In other words, the control unit B1 sets the widths w1 and w3 of the toner pattern, i.e., predetermined toner image, in the direction of rotation of the photosensitive drum 1 of the area corresponding to the range in which the outer circumference surface of the conveyance roller is disposed in the rotational axis direction X of the photosensitive drum 1 to be wider than the toner pattern widths w2 and w4 in the areas other than the corresponding areas described above.

The roller corresponding area A1 includes an area in which a surface of the feed roller 84 that comes into contact with the sheet S, i.e., the outer circumference surface of the feed roller 84, is disposed in the rotational axis direction X of the photosensitive drum 1. The roller corresponding area A1 has a width of L1+2 (mm) in which a margin of 1 mm is provided on either side in the rotational axis direction X of an outer circumference surface width, i.e., roller width L1, of the feed roller 84. The roller corresponding area A2 includes a range in which the surface of the feed roller 89 comes into contact with the sheet S, i.e., outer circumference surface of the feed roller 89, in the rotational axis direction X of the photosensitive drum 1. The roller corresponding area A2 has a width of L2+2 (mm) in which a margin of 1 mm is provided on either side in the rotational axis direction X of the outer circumference surface, i.e., roller width L2, of the feed roller 89.

The widths of the roller corresponding areas A1 and A2 are each set greater than the roller widths L1 and L2 of the feed rollers 84 and 89, in order to maintain the cleaning performance more reliably by taking into consideration the skewing or misregistration of the sheet S or misregistration of the process cartridge 70. The width of each margin is not limited to 1 mm, and it may be wider than 1 mm, or the margin may not be set at all. The roller width L1 of the feed roller 84 is 30 mm, for example, and the width L2 of the outer circumference surface of the feed roller 89 is 20 mm, for example. That is, a relationship of L1>L2 is realized according to the present embodiment.

In the present embodiment, the feed rollers 84 and 89 are each a single roller that is arranged at a center portion in the rotational axis direction X of the photosensitive drum 1. Along therewith, the roller corresponding areas A1 and A2 are each a single area that is set at the center portion in the rotational axis direction X of the photosensitive drum 1. Further, the toner pattern is formed to have a symmetrical shape with the center of the conveyance path in the rotational axis direction X set as the axis of symmetry.

In a case where the feed roller 84 includes a plurality of rollers aligned in the rotational axis direction X of the photosensitive drum 1, the roller corresponding area A1 may be a plurality of areas aligned in the rotational axis direction X. Similarly, in a case where the feed roller 89 includes a plurality of rollers aligned in the rotational axis direction X of the photosensitive drum 1, the roller corresponding area A2 may be a plurality of areas aligned in the rotational axis direction X. Further, if a contact area of the feed roller 84 or 89 against the sheet S is not symmetrical with respect to the center of the conveyance path, the position of the roller corresponding area A1 or A2 is not necessarily symmetrical with respect to the center of the conveyance path.

During image formation, the sheet S is not only rubbed against the conveyance guides 91, 92, 93, and 94, but also rubbed against the conveyance roller. Specifically, at the separation nip Ns1 between the feed roller 84 and the separation roller 83, the sheet S is conveyed against the frictional force that the sheet S receives from the separation roller 83 and that is opposite to the sheet conveyance direction, such that the feed roller 84 rubs the sheet S strongly. Similarly, at the separation nip Ns2 between the feed roller 89 and the separation roller 90, the sheet S is conveyed against the frictional force that the sheet S receives from the separation roller 90 and that is opposite to the sheet conveyance direction, such that the feed roller 89 rubs the sheet S strongly. Therefore, compared to the areas other than the roller corresponding areas A1 and A2, paper dust tends to occur at the roller corresponding areas A1 and A2.

Therefore, by setting the toner pattern width w1 in the roller corresponding area A1 to be wider than the toner pattern width w2 in other areas, deterioration of cleaning performance caused by paper dust that occurs by the rubbing of the sheet S against the feed roller 84 may be suppressed. Further, by setting the toner pattern width w3 in the roller corresponding area A2 to be wider than the toner pattern width w4 in other areas, deterioration of cleaning performance caused by paper dust that occurs by the rubbing of the sheet S against the feed roller 89 may be suppressed. Further, by setting the toner pattern widths w2 and w4 of the areas other than the roller corresponding areas A1 and A2 to be relatively narrow, toner consumption by the toner purge operation may be reduced while achieving the advantage of suppressing deterioration of cleaning performance.

In other words, an area corresponding to a range in which the outer circumference surface of the conveyance roller is disposed in the rotational axis direction X of the photosensitive drum 1, for example, the roller corresponding area A1, is referred to as a first area. In that case, the control unit B1 sets the width of the predetermined toner image in the first area regarding the direction of rotation of the photosensitive drum 1 to be greater than the width of the predetermined toner image in areas other than the first area.

Thereby, toner may be supplied to the blade nip 6 N, i.e., contact portion, by a more appropriate distribution with respect to the rotational axis direction X corresponding to the area in which the outer circumference surface of the conveyance roller is disposed. Thus, toner consumption by the toner purge operation may be reduced while suppressing the deterioration of cleaning performance caused by paper dust that occurs by the rubbing of the conveyance roller against the sheet S.

According further to the present embodiment, the areas in which the toner pattern width is widened, i.e., the roller corresponding areas A1 and A2, are changed to correspond to the difference of the roller widths L1 and L2 of the feed rollers 84 and 89. In other words, the feed roller 84 serves as an example of a first conveyance roller, and the separation roller 83 serves as a first separation member. In this case, the image forming apparatus 100 includes the feed roller 89 serving as a second conveyance roller that conveys sheets toward the transfer portion via a path that differs from the path through which a sheet is conveyed by the first conveyance roller. Further, the image forming apparatus 100 includes the separation roller 90 serving as a second separation member that forms a separation nip together with the second conveyance roller and that separates sheets by applying a frictional force in an opposite direction as the sheet conveyance direction by the second conveyance roller to the sheet. A width of the outer circumference surface of the first conveyance roller in the rotational axis direction X of the photosensitive drum 1 differs from a width of the outer circumference surface of the second conveyance roller in the rotational axis direction X. In a case where a toner supplying operation is executed after the image forming operation to the sheet conveyed to the transfer portion via the second conveyance roller, the control unit B1 sets the width of the predetermined toner image with respect to the direction of rotation at a second area corresponding to the range in which the outer circumference surface of the second conveyance roller is disposed in the rotational axis direction X to be greater than the width of the predetermined toner image in areas other than the second area.

Thereby, toner may be supplied to the blade nip 6N by a more appropriate distribution in the rotational axis direction X according to the difference in widths of the outer circumference surfaces of the first conveyance roller and the second conveyance roller.

### Control Flow

FIG. 7 is a flowchart illustrating an example of execution sequence of an image forming job according to the second embodiment. The respective steps of the present flowchart are performed by the CPU of the control unit B1 (FIG. 3) executing a program read from the storage unit.

The processes of S201 to S205 are similar to the processes of S101 to S105 according to the flow (FIG. 5) of the first embodiment, such that descriptions thereof are omitted. The calculation method of the determination value of toner purge amount may adopt Expression (1) described in the first embodiment, or may adopt the calculation method described in the modified example of the first embodiment. In S206, the control unit B1 compares the determination value of the toner purge amount calculated in S205 with the threshold value set in advance.

If it is determined in S206 that the determination value is greater than the threshold value, the control unit B1 determines the supply source of the sheet S used for the current image forming job in S207. If it is determined in S207 that the supply source of the sheet S is the sheet cassette 80, in S209, the control unit B1 sets the toner pattern width in the roller corresponding area A1 to 10 mm and sets the toner pattern width in the areas other than the roller corresponding area A1 to 7.5 mm. If it is determined in S207 that the supply source of the sheet S is not the sheet cassette 80, in S210, the control unit B1 sets the toner pattern width in the roller corresponding area A2 to 10 mm and sets the toner pattern width in the areas other than the roller corresponding area A2 to 7.5 mm.

If it is determined in S206 that the determination value is equal to or smaller than the threshold value, the control unit B1 determines the supply source of the sheet S used for the current image forming job in S208. If it is determined in S208 that the supply source of the sheet S is the sheet cassette 80, in S211, the control unit B1 sets the toner pattern width in the roller corresponding area A1 to 5 mm and sets the toner pattern width in the areas other than the roller corresponding area A1 to 4 mm. If it is determined in S208 that the supply source of the sheet S is not the sheet cassette 80, in S212, the control unit B1 sets the toner pattern width in the roller corresponding area A2 to 5 mm and sets the toner pattern width in the areas other than the roller corresponding area A2 to 4 mm.

In S213, the control unit B1 executes the toner purge operation during post-rotation of the current job. In that state, the toner pattern is formed according to the toner purge amount, i.e., toner pattern width, set in S209 to S212, and toner is supplied to the blade nip 6N.

In S214, the control unit B1 stops application of the charging voltage and the developing voltage, stops the rotation of the motor M1, and thereafter, ends the sequence of the image forming job. The rotation of the motor M1 is stopped at a timing after the entirety of the toner pattern formed by the toner purge operation has arrived at the blade nip 6N.

### Evaluation Experiment 2

In order to evaluate the cleaning performance and the toner consumption amount according to the configuration of the present embodiment, experiments were performed by an experiment method similar to the evaluation experiment 1 described above. In comparative example 1, the toner pattern width was fixed to 7.5 mm regardless of the conveyance path of the sheet S, and the toner pattern width was constant (FIG. 6A). In the first embodiment, as described above, the toner pattern width was set to 5 mm or 10 mm according to the conveyance path of the sheet S, and the toner pattern width was constant (FIG. 6A). In the second embodiment, the toner pattern widths w1 to w4 were varied according to the conveyance path of the sheet S and also according to the position in the rotational axis direction X of the photosensitive drum 1 (FIG. 6B). The processes of the intermittent printing operation, and the method and basis for evaluating the cleaning performance and the toner consumption amount are the same as those of evaluation experiment 1.

Table 2 shows the settings of the toner purge amount, i.e., toner pattern width in the toner purge operation, and evaluation results of the cleaning performance and the toner consumption amount, i.e., number of sheets before occurrence of void, according to comparative example 1 and first and second embodiments.

TABLE 2

| | | COMPARATIVE | FIRST | SECOND |
|---|---|---|---|---|
| | | EXAMPLE 1 | EMBODIMENT | EMBODIMENT |
| TONER PURGE AMOUNT | ROLLER | 7.5 mm | 5 mm/10 mm | 5 mm/10 mm |
| (TONER PATTERN WIDTH) | CORRESPONDING AREA | | | |
| | OTHER THAN ROLLER | 7.5 mm | 5 mm/10 mm | 4 mm/7.5 mm |
| | CORRESPONDING AREA | | | |
| EVALUATION OF CLEANING | CENTER PORTION | Good | Good | Good |
| PERFORMANCE: | OTHER THAN | Poor | Good | Good |
| PRESENCE OF VERTICAL | CENTER PORTION | | | |
| STRIPES | | | | |

| | | | |
|---|---|---|---|
| EVALUATION OF TONER CONSUMPTION AMOUNT: | 41 | 41 | 44 |
| NUMBER OF SHEETS BEFORE OCCURRENCE OF VOID | | | |
| (1000 SHEETS) | | | |

As illustrated in Table 1, according to comparative example 1, vertical stripes occurred at the center portion of the image, and the evaluation of the cleaning performance was “Poor”. This is considered to be caused by the reformation of the lubricating layer 6a being insufficient when the image forming operation was executed in a condition where there is a large amount of paper dust, as described in evaluation experiment 1. Further, it is considered that a large amount of dust occurs at the center portion where the feed rollers 84 and 89 are disposed compared to areas other than the center portion, and that the reformation of the lubricating layer 6a tends to be even more insufficient.

In the first embodiment, as similarly described above in evaluation experiment 1, the evaluation of the cleaning performance was “Good”, and the number of sheets before occurrence of void was 41 K sheets, equivalent to the comparative example 1.

In the second embodiment, the evaluation of the cleaning performance was “Good”, and the number of sheets before occurrence of void was 44 K sheets, which was better than the comparative example 1 and the first embodiment. This is because, according to the second embodiment, by setting the toner purge amounts at the roller corresponding areas A1 and A2 to values equivalent to those of the first embodiment, the deterioration of cleaning performance was suppressed at the center portion where the amount of paper dust tends to be increased by the rubbing of the feed rollers 84 and 89 against the sheet S. Further, according to the second embodiment, in the area other than the center portion where the amount of paper dust is small compared to the center portion, the toner purge amount at areas other than the roller corresponding areas A1 and A2 was set smaller than that of the first embodiment, such that the toner consumption by the toner purge operation was suppressed.

According to the second embodiment, it is possible to suppress the reduction of the printable number of sheets caused by excessive toner consumption during the toner purge operation, and to suppress the deterioration of cleaning performance by the depletion of the lubricating layer 6a.

Specifically, according to the second embodiment, the toner purge amount at the roller corresponding areas A1 and A2 corresponding to the feed rollers 84 and 89 is set greater than the toner purge amount at areas other than the roller corresponding areas A1 and A2. Thereby, the amount of toner consumed by the toner purge operation may be reduced even further and the printable number of sheets may be improved while suppressing the deterioration of the cleaning performance.

### Modified Example

In the second embodiment, a configuration in which a control for changing the shape of the toner pattern according to the positions of the feed rollers 84 and 89 (S207 to S212) is performed in combination with the control using the determination value of the toner purge amount similar to the first embodiment (S204 to S206) was described. The present technique is not limited thereto, and the control for changing the shape of the toner pattern according to the positions of the feed rollers 84 and 89 can be executed alone.

For example, in a case where the sheet Sis fed from the sheet cassette 80 in the image forming operation, the toner purge operation is executed using a toner pattern (FIG. 6B) having the width w1 that is wide in the roller corresponding area A1 corresponding to the feed roller 84. In this state, the sheet S is conveyed via the first conveyance path P1 having a small minimum radius of curvature R1, such that the toner pattern width w1 in the roller corresponding area A1 is set to 10 mm, for example, and the toner pattern width w1 in other areas is set to 7.5 mm, for example. Further, in a case where the sheet S is fed from the manual feed tray 81 in the image forming operation, the toner purge operation is executed using a toner pattern (FIG. 6B) having the width w3 that is wide in the roller corresponding area A2 corresponding to the feed roller 89. In this state, the sheet S is conveyed via the second conveyance path P2 having a large minimum radius of curvature R2, such that the toner pattern width w3 in the roller corresponding area A2 is set to 5 mm, for example, and the toner pattern width w4 in other areas is set to 4 mm, for example.

### Third Embodiment

A configuration in which a toner purge amount is changed based on whether the setting of an image forming job is a simplex printing or a duplex printing is described as the third embodiment. Hereinafter, components assigned with the same reference numbers as the first embodiment have basically a same configuration and same effect as those described in the first embodiment, unless denoted otherwise, and portions that differ from the first embodiment will mainly be described below.

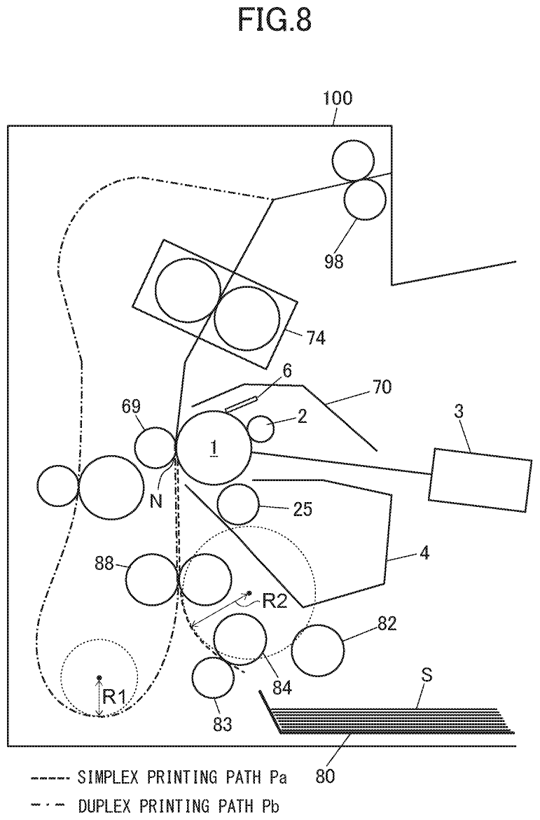

FIG. 8 is a schematic view of the image forming apparatus according to the present embodiment. The image forming apparatus according to the present embodiment includes a simplex printing path Pa and a duplex printing path Pb. In a case where the duplex printing path Pb is referred to as a first conveyance path, the simplex printing path Pa may be referred to as a second conveyance path.

The image forming apparatus includes a reversing roller pair 98 serving as a reversing member. The reversing roller pair 98 reverses and conveys the sheet S having passed through a fixing portion 74 toward the duplex printing path Pb. The reversing and conveying operation is a series of operations, i.e., switch-back operation, in which the reversing roller pair 98 conveys the sheet S in a first conveyance direction, rotates in a reverse direction before the trailing edge of the sheet S in the first conveyance direction passes through the nip portion of the reversing roller pair 98, and conveys the sheet S toward a second conveyance direction opposite to the first conveyance direction.

The simplex printing path Pa is a conveyance path through which the sheet S is conveyed from the sheet cassette 80, i.e., supporting portion, via the separation nip and the registration roller pair 88 toward the transfer nip N, i.e. transfer portion. The duplex printing path Pb is a conveyance path through which the sheet S being reversed by the reversing roller pair 98 is conveyed toward the transfer nip N, i.e., transfer portion.

In a case where a simplex printing for forming an image on only one surface of the sheet S is set as the image forming job, toner image is transferred to a first surface of the sheet S conveyed from the sheet cassette 80 through the simplex printing path Pa to the transfer nip N. Thereafter, the sheet S being passed through the fixing portion 74 is discharged to the exterior of the apparatus without being sent to the duplex printing path Pb.

In a case where a duplex printing for forming an image on both surfaces of the sheet S is set as the image forming job, toner image is transferred to the first surface of the sheet S in a similar manner as in the simplex printing, passed through the fixing portion 74, reversed by the reversing roller pair 98, and sent to the duplex printing path Pb. A toner image is transferred to a second surface of the sheet S conveyed again to the transfer nip N through the duplex printing path Pb. Then, after passing through the fixing portion 74, the sheet S is discharged to the exterior of the apparatus by the reversing roller pair 98.

The duplex printing path Pb includes a curved portion that is curved in a U shape. In the illustrated example, the direction of movement of the sheet S at the transfer nip N is upward with respect to the vertical direction, and the main direction of movement of the sheet S in the duplex printing path Pb is downward with respect to the vertical direction. Therefore, a curved portion that is curved to guide the sheet S that has been conveyed downward to the upward direction is provided at the lower portion of the duplex printing path Pb. The minimum radius of curvature R1 of the duplex printing path Pb is smaller than the minimum radius of curvature R2 of the simplex printing path Pa. Paper dust tends to occur by the sheet S rubbing against the conveyance guide when passing through the curved portion of the duplex printing path Pb.

The control unit B1 according to the present embodiment changes the toner purge amount depending on whether the setting of the image forming job is a simplex printing or a duplex printing. For example, when executing the image forming job of a simplex printing, the control unit B1 sets the toner pattern width to 5 mm and executes the toner purge operation during post-rotation. When executing the image forming job of a duplex printing, the control unit B1 sets the toner pattern width to 10 mm and executes the toner purge operation during post-rotation. In other words, the execution condition of the toner purge operation is changed such that the toner purge amount during duplex printing is set greater than the toner purge amount during simplex printing. Thereby, the influence of paper dust that occurs at the curved portion of the duplex printing path Pb may be reduced to suppress the deterioration of cleaning performance, while the toner purge amount during simplex printing is reduced to increase the printable number of sheets.

The control method described above may be realized by replacing the term first conveyance path P1 with the duplex printing path Pb, and the term second conveyance path P2 with the simplex printing path Pa in the control method described in the first embodiment (FIG. 5).

Further, in the simplex printing path Pa, paper dust occurs by the sheet S rubbing against the feed roller 84 opposed to the separation roller 83, whereas a conveyance roller that is opposed to the separation member, such as a separation roller, is not disposed in the duplex printing path Pb. Therefore, depending on the image forming condition, a greater amount of paper dust may be generated during simplex printing than during duplex printing even if the number of images being output during a job is the same.

Therefore, the control unit B1 can change the execution condition of the toner purge operation such that the toner purge amount during simplex printing becomes greater than the toner purge amount during duplex printing. The setting of the toner purge amount may be changed according to the actual configuration of the image forming apparatus.

According to the present embodiment, an image forming apparatus capable of supplying a more appropriate amount of toner to the contact portion between the cleaning member and the photosensitive drum can be provided.

### Other Modified Examples

The conveyance paths of the sheet S during image formation is changed between the cassette feed path and the manual feed path according to the first embodiment, and they are changed between the simplex printing path and the duplex printing path according to the third embodiment, but the present technique may also be applied to an image forming apparatus having conveyance paths other than those illustrated above. For example, the image forming apparatus may include a plurality of sheet cassettes that are aligned vertically or horizontally. In that case, the tendency of generation of paper dust may differ between a conveyance path through which the sheet S fed from one sheet cassette is conveyed and a conveyance path through which the sheet S fed from another sheet cassette is conveyed, due to the differences in minimum radius of curvatures or nipping pressures at the separation nip. Therefore, the toner purge amount may be changed depending on the sheet cassette from which the sheet S is conveyed during image formation.

### Other Modifications

The present disclosure is not limited to the embodiments described above, and for example, all or a portion of the above-mentioned embodiments may be combined and executed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067694, filed Apr. 16, 2025, which is hereby incorporated by reference herein in its entirety.

What is claimed is:

1. An image forming apparatus comprising:
a photosensitive drum configured to rotate;
a transfer member configured to form a transfer portion at which a toner image is transferred from the photosensitive drum to a sheet;
a cleaning member configured to come into contact with the photosensitive drum and remove toner that has not been transferred to the sheet at the transfer portion from a surface of the photosensitive drum; and
a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum,
wherein the control unit is configured to set a first toner amount and a second toner amount to different amounts, the first toner amount being an amount of toner to be supplied to the contact portion by the toner supplying operation when executing the toner supplying operation after the image forming operation performed to a sheet conveyed to the transfer portion via a first conveyance path, the second toner amount being an amount of toner to be supplied to the contact portion by the toner supplying operation when executing the toner supplying operation after the image forming operation performed to a sheet conveyed to the transfer portion via a second conveyance path that differs from the first conveyance path.

2. The image forming apparatus according to claim 1, further comprising:
a first supporting portion on which a sheet to be conveyed to the transfer portion via the first conveyance path is supported; and
a second supporting portion on which a sheet to be conveyed to the transfer portion via the second conveyance path is supported.

3. The image forming apparatus according to claim 2, further comprising:
a first feeding member configured to feed a sheet supported on the first supporting portion toward a side opposite to a direction of movement of the sheet at the transfer portion, with respect to a direction parallel to the direction of movement of the sheet, and
a second feeding member configured to feed a sheet supported on the second supporting portion toward a same side as the direction of movement, with respect to the direction parallel to the direction of movement.

4. The image forming apparatus according to claim 3,
wherein the first conveyance path is curved to guide the sheet, which has been fed by the first feeding member toward the side opposite to the direction of movement of the sheet, toward a direction along the direction of movement, and
wherein the control unit is configured to set the first toner amount to be greater than the second toner amount.

5. The image forming apparatus according to claim 2, further comprising:
an apparatus body configured to accommodate the photosensitive drum and the transfer member,
wherein the first supporting portion is attached to the apparatus body so as to be drawable therefrom, and
wherein the second supporting portion is a manual feed tray configured to protrude from the apparatus body and to allow a user to set a sheet from an exterior of the apparatus body.

6. The image forming apparatus according to claim 1, further comprising:
a supporting portion configured to support a sheet; and
a reversing member configured to reverse and convey a sheet having passed through the transfer portion,
wherein the first conveyance path is a path through which the sheet that has been reversed and conveyed by the reversing member is conveyed toward the transfer portion, and
wherein the second conveyance path is a path through which the sheet is conveyed from the supporting portion toward the transfer portion.

7. The image forming apparatus according to claim 1,
wherein a minimum radius of curvature of the first conveyance path is smaller than a minimum radius of curvature of the second conveyance path, and
wherein the control unit is configured to set the first toner amount to be greater than the second toner amount.

8. The image forming apparatus according to claim 7,
wherein the minimum radius of curvature of the first conveyance path is a minimum value of a radius of curvature of a surface of a conveyance guide that forms the first conveyance path when viewed in a rotational axis direction of the photosensitive drum, and
wherein the minimum radius of curvature of the second conveyance path is a minimum value of a radius of curvature of a surface of a conveyance guide that forms the second conveyance path when viewed in the rotational axis direction.

9. The image forming apparatus according to claim 1, wherein the control unit is configured to change an amount of toner to be supplied to the contact portion by the toner supplying operation by changing a width of the predetermined toner image in a direction of rotation of the photosensitive drum.

10. The image forming apparatus according to claim 1, wherein, upon receiving an image forming job from a user, the control unit is configured to execute the toner supplying operation during a period of time after toner images are transferred to all of the number of sheets designated by the user and before rotational driving of the photosensitive drum is stopped.

11. The image forming apparatus according to claim 1, further comprising:
a conveyance roller configured to convey a sheet toward the transfer portion; and
a separation member configured to form a separation nip together with the conveyance roller, and to separate the sheet by applying a frictional force to sheets at the separation nip, in an opposite direction as a direction in which the sheet is conveyed by the conveyance roller,
wherein the conveyance roller includes an outer circumference surface that comes into contact with the sheet, and
wherein the control unit is configured to set a width of the predetermined toner image with respect to a direction of rotation of the photosensitive drum within a first area to be greater than a width of the predetermined toner image in an area other than the first area, the first area corresponding to an area in which the outer circumference surface is disposed with respect to a rotational axis direction of the photosensitive drum.

12. The image forming apparatus according to claim 11,
wherein, in a case where the conveyance roller is referred to as a first conveyance roller, and the separation member is referred to as a first separation member,
the image forming apparatus further comprises:
a second conveyance roller configured to convey an other sheet toward the transfer portion via a path that differs from that of the sheet conveyed by the first conveyance roller; and
a second separation member configured to form a separation nip together with the second conveyance roller, and to separate the other sheet by applying a frictional force to sheets in a direction opposite to a direction in which the other sheet is conveyed by the second conveyance roller,
wherein a width of the outer circumference surface of the first conveyance roller with respect to the rotational axis direction differs from a width of an outer circumference surface of the second conveyance roller with respect to the rotational axis direction, and wherein, in a case where the toner supplying operation is performed after performing the image forming operation to a sheet conveyed to the transfer portion via the second conveyance roller, the control unit is configured to set a width of the predetermined toner image with respect to the direction of rotation in a second area to be greater than a width of the predetermined toner image in an area other than the second area, the second area corresponding to a range in which the outer circumference surface of the second conveyance roller is disposed in the rotational axis direction.

13. An image forming apparatus comprising:
a photosensitive drum configured to rotate;
a transfer member configured to form a transfer portion at which a toner image is transferred to a sheet from the photosensitive drum;
a conveyance roller configured to convey a sheet toward the transfer portion;
a separation member configured to form a separation nip together with the conveyance roller, and to separate the sheet by applying a frictional force to sheets at the separation nip, in an opposite direction as a direction in which the sheet is conveyed by the conveyance roller,
a cleaning member configured to come into contact with the photosensitive drum and remove toner that has not been transferred to the sheet at the transfer portion from a surface of the photosensitive drum; and
a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum,
wherein the conveyance roller includes an outer circumference surface that comes into contact with a sheet, and
wherein the control unit is configured to set a width of the predetermined toner image with respect to a direction of rotation of the photosensitive drum in a first area to be greater than a width of the predetermined toner image in an area other than the first area, the first area corresponding to a range in which the outer circumference surface is disposed in a rotational axis direction of the photosensitive drum.

14. The image forming apparatus according to claim 13,
wherein, in a case where the conveyance roller is referred to as a first conveyance roller, and the separation member is referred to as a first separation member,
the image forming apparatus further comprises:
a second conveyance roller configured to convey an other sheet toward the transfer portion via a path that differs from that of the sheet conveyed by the first conveyance roller; and
a second separation member configured to form a separation nip together with the second conveyance roller, and to separate the other sheet by applying a frictional force to sheets in an opposite direction as a direction in which the other sheet is conveyed by the second conveyance roller,
wherein a width of the outer circumference surface of the first conveyance roller with respect to the rotational axis direction differs from a width of an outer circumference surface of the second conveyance roller with respect to the rotational axis direction, and
wherein, in a case where the toner supplying operation is performed after performing the image forming operation to a sheet conveyed to the transfer portion via the second conveyance roller, the control unit is configured to set a width of the predetermined toner image with respect to the direction of rotation in a second area to be greater than a width of the predetermined toner image in an area other than the second area, the second area corresponding to a range in which the outer circumference surface of the second conveyance roller is disposed in the rotational axis direction.
